(19) United States
(12) Patent Application Publication
(10) Pub. No.: US 2026/0127650 A1
(43) Pub. Date: May 7, 2026

(54) SYSTEMS AND METHODS FOR PROPERTY TRANSACTIONS USING SECURE AUTOMATED PROCESSES

(71) Applicants: Bradford Ashe, Fort Lauderdale, FL (US); Edward Ashe, Fort Lauderdale, FL (US)

(72) Inventors: Bradford Ashe, Fort Lauderdale, FL (US); Edward Ashe, Fort Lauderdale, FL (US)

(21) Appl. No.: 19/378,251

(22) Filed: Nov. 3, 2025

Related U.S. Application Data
(60) Provisional application No. 63/715,539, filed on Nov. 2, 2024.

(51) Int. Cl. G06Q 30/0601; G06Q 10/1093; G06Q 50/16; G06V 40/16; H04L 67/306

(52) U.S. Cl. CPC G06Q 30/0627; G06Q 10/1093; G06Q 30/0641; G06Q 50/167; G06V 40/172; H04L 67/306

(57) ABSTRACT

A system and method for facilitating real property transactions directly between buyers and sellers utilizes a platform accessible via a website and/or mobile application. Buyers and sellers create accounts by providing verification of their identities. The system verifies ownership of properties offered for sale, and financial information provided by buyers. Mortgage lenders preapprove buyers based on the verified financial information. Buyers schedule viewings of a property, then provide offers to purchase to sellers. Property sales are negotiated via the platform. Buyers may hire inspectors to view the property and the sales agreement may be further negotiated based on the inspection. Sellers may use the platform to obtain repair or other services for the property. Once a sale is agreed to, the platform prepares the required documentation, obtains signatures and facilitates proper recording of all documents.

### STATEMENT REGARDING FEDERALLY SPONSORED RESEARCH OR DEVELOPMENT

### Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable

### BACKGROUND OF THE INVENTION

### Field of the Invention

The present invention relates to an online transaction platform. More particularly, the invention relates to systems and methods for secure property transactions via a comprehensive online and mobile application platform that simplifies the process of real estate transactions, such as buying, selling, leasing, exchanging, or trading properties.

### Description of the Related Art

There are currently many websites, computer listings, and multiple listing services which provide listings of real properties for sale, lease, and/or exchange with the assistance or services of a licensed real estate broker. However, these sites do not allow the buyers and sellers to negotiate their fees separately. They do not allow Buyer's to obtain lender approval for a purchase. They generally also do not allow buyers to schedule showings (viewing of property real or other) directly with the sellers or agents.

The recent Supreme Court ruling in Sitzer v. National Association of Realtors now requires that buyers of real property must be offered an opportunity to negotiate commissions or fees paid by the buyer. SCOTUS's Ruling has created a void in the market place; there is a need to simplify and facilitate the greater control buyers now enjoy over real estate transactions.

The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

In view of the foregoing, it is desirable to provide systems and methods to facilitate sales of property directly between a seller and buyer.

### BRIEF SUMMARY OF THE INVENTION

Disclosed is an online and mobile application platform that simplifies the process of real estate transactions, such as buying, selling, leasing, exchanging, or trading properties. The platform of the invention may include biometric verification, real-time API integration with mortgage lenders, automated lockbox systems, and/or electronic signature capabilities to facilitate direct and secure interactions between buyers, sellers, principals, and other real estate professionals, thereby reducing transaction time and associated costs.

The present invention empowers buyers and sellers with the tools, information, knowledge base, answers to frequently asked questions, and access to information necessary to complete a real estate transaction in writing as principals themselves or with minimum help from technical, real estate agency support, and/or legal support.

The present invention allows buyers and sellers to avoid paying large commissions by allowing them to negotiate directly, and thus paying no commission, a reduced fee, or merely pay an access fee for the use of the web portal of the invention and its tools, forms, and answers to common questions. The present invention incorporates and simplifies many of the steps of a real estate, and other, transactions directly between buyers and sellers.

The present invention gives buyers access to lenders for pre-approval and mortgage loan approval, as well as access to the sellers for scheduling viewing of a property. LendingTree® is an example of a website/web portal where banks and lending or loan companies compete for borrowers' business. In addition to access to lenders, the present invention gives approved buyers access to scheduling features of its website and/or web portal.

The present invention allows users to securely list, search, and transact properties. The system leverages digital identification and real-time biometrics verification for user authentication, automated lockbox management, and seamless integration with mortgage lenders and other affiliates.

It is therefore an object of the present invention to provide systems and methods to facilitate sales of property directly between the seller and buyer using an automated online or mobile platform that reduces or eliminates the need to incorporate third parties such as real estate agencies into the transaction and sales process.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices are shown in block diagram form in order to facilitate describing the various embodiments herein. Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

Unless otherwise indicated, all numbers expressing quantities of ingredients, dimensions, reaction conditions and so forth used in the specification and claims are to be understood as being modified in all instances by the term “about”. The term “a” or “an” as used herein means “at least one” unless specified otherwise. In this specification and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

Various embodiments of the disclosure could also include permutations of the various elements recited in the claims as if each dependent claim was a multiple dependent claim incorporating the limitations of each of the preceding dependent claims as well as the independent claims. That is, the combinations of the various components of the invention are not limited to those combinations expressly shown in the Figures. Unless expressly stated otherwise, components described in one embodiment may be interchanged with components of the same name found in other embodiments. Such permutations are expressly within the scope of this disclosure.

The systems and methods of the present invention provide an all-in-one platform designed to facilitate direct interactions between buyers, sellers, lessors, lessees, exchangers, traders, principals and the like. The platform provides all the necessary tools, legal forms, and resources for completing real estate transactions efficiently. These include signing forms, filing titles and deeds, and integrating various services such as plumbing, construction, and moving during the transaction process. Optionally, real estate brokers and agents can use the platform of the invention to offer their services, or in the performing of their services. All offers to purchase or sell property must be made in writing, as required by law. Buyers and sellers (or their agents/brokers) can accept, reject, or counter offers directly within the BSD platform. The systems and methods of the present invention do not themselves offer properties for sale. Rather, it provides a platform, through a mobile app and/or website, that facilitates communications and transactions between principals, i.e. buyers and sellers or their licensed agents. The platform of the invention may charge scaled fees for its services, access, and membership. However, these are substantially lower than the typical costs usually associated with the sale of real estate.

The steps for using the systems and methods of the invention by a Seller/User include:

First, a seller/broker/representative connects to an online or mobile app platform of the invention and creates an account with a secure username and password. Then the seller/user provides proof of identity using any of a variety of methods. For example, the seller/user may utilize a government issued “Real Identification,” “Real ID” (as required for airline travel), verification through facial recognition software via a real time mobile device or computer using an API application, or other interface using a real time biometrics facial recognition interfaces to correspond to the “Real ID” with a selfie picture/scan.

Next, the seller/user is required to upload proof of ownership of a property to be sold, e.g. a deed or other public record. The user/sell may then upload photos of property, walk through videos of property, and the like. Once all documents and identity are approved and/or verified, the seller/user may list the property for sale or lease. Optionally, the seller/user may receive a new lockbox or coordinate an existing lockbox for the property. A new lockbox can be shipped to them automatically by the platform of the invention or optionally by an affiliate/partner to install on the property. The lockbox may be an automatic lockbox connected to showings arranged via the system of the invention. After a buyer obtains loan approval through the system of the invention and permission of the seller, the lockbox may be unlocked remotely at a preapproved showing/viewing time generated through the system of the invention.

The steps for using the systems and methods of the invention by buyer/user include:

First the buyer/user accesses the system of the invention via a website or mobile application and creates a secure account with username and password, in the same manner as a seller/user. Next, a buyer/users provides verification of his or her identity, again in a manner similar to that of a seller. Once verified, a buyer may apply for mortgages through banks and other lenders through the platform of the invention. Once a buyer is pre-approved, he or she can begin looking for properties in a range based on their loan approval and budget.

When a buyer finds a property he or she is interested in purchasing, the buyer can book a showing and view the property. As an example, a buyer can book an appointment for 4:00 pm on a given day. When the buyer arrives, they can click “I'm here” on the mobile app of the invention.

The system of the invention will then unlock the door or lockbox, and the buyer can view the property for a predetermined amount of time. When the viewing is complete, the buyers leaves the property and the door or Lockbox will automatically lock.

If the buyer wishes, he or she may then submit an offer to purchase the property. The seller may then choose to accept, reject or counter the buyer's offer. If the offer is not accepted by the seller, the buyer can negotiate further with seller to hopefully come to an agreement on price, terms, and conditions for an agreement to purchase the property. The system of the invention may prepare the agreement, automatically inserting the terms agreed to by the parties.

Once the price, terms and conditions of the sale have been agreed to, the buyer and seller may be provided with a list of qualified home inspectors. The buyer then selects an inspector, the system of the invention may be used to schedule an appointment for an inspection of the property. If an inspection identifies problems with the property, the system of the invention will provide options to correct the issues, to cancel the sale, or to renegotiate the sales agreement. After the inspection and any corrections or renegotiations, the system of the invention generates a final sales agreement and facilitates the signing by both parties, and can complete other legal documentation to finalize the sale. The lender may then transfer funds to a title company provider and the required paperwork will be duly recorded in the appropriate Jurisdiction.

The steps for using the systems and methods of the invention by a mortgage lender include:

Mortgage lenders, including banks or other lending institutions, may access the platform of the invention to obtain the verified information of buyers seeking a mortgage. These lenders may submit quotes and offers directly to buyers for their review, consideration and or acceptance. Buyers will have the option to choose from the quotes they have received from lenders to purchase a desired property.

Thus, those skilled in the art will appreciate that the present invention provides a multifaceted platform for facilitating direct interactions between buyers and sellers. It also provides tools, legal forms, and relevant information for buyers and sellers of real property. The system of the invention is also readily adapted for leasing and renting properties in addition to sales. The platform of the invention may include additional resources, such as service providers for plumbing, electrical, construction, moving, and the like, commonly needed when real property is transferred to a new owner or lessee.

The platform of the invention also ensures that the entire process is performed in accordance with all relevant laws and regulations. For example, the system ensures that all offers to buy or sell are in writing as required by law. Buyers and Sellers can accept, reject, or counter offers made in writing. All offers are made by qualified Principals, Buyer(s) and or Seller(s) scale based fees for BSD services, access, and membership.

Whereas, the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. Descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

1. A method for facilitating direct selling of any type of real or other property, comprising:
a user interface for sellers to list properties for sale;
a search module for buyers to locate properties based on predefined criteria;
an integrated communication tool allowing direct messaging between sellers and buyers; and,
a transaction management system to handle offers, counteroffers, and sales agreements.

2. The method of claim 1 further comprising a server configured to host a website facilitating the listing and searching of properties; a database storing property listings, user profiles, and transaction records; and an algorithm for matching buyers with sellers based on criteria such as price, location, and property features;
wherein the user interface includes interactive maps displaying property locations; virtual tour capabilities allowing buyers to view properties remotely; options for scheduling in-person viewings.

3. A computer-implemented platform system for facilitating real estate transactions between buyers and sellers, comprising:
a user interface accessible via a website or mobile application for account creation, enabling sellers and buyers to create secure profiles with unique identification credentials;
an identity verification module configured to verify users' identities using government-issued identification, facial recognition, or real-time biometrics;
a document submission module that allows sellers to upload property ownership verification and other legal documents required for listing properties;
a property listing feature enabling sellers to list properties with descriptive details, including photos and videos;
an automated lockbox system configured to facilitate secure property access for verified buyers at scheduled times, where the lockbox is activated and deactivated via the platform;
an offer management module allowing buyers to submit, and sellers to accept, reject, or counter purchase offers in compliance with legal requirements for written offers;
a mortgage pre-approval and lender selection module, wherein verified buyers receive and review mortgage quotes from lenders, allowing buyers to select a lender based on loan terms;
an inspection coordination module that provides buyers with a list of available home inspectors and schedules inspections as requested by the buyer;
a final agreement generation module that automatically prepares a final sales agreement after inspection, terms, and condition acceptance by the parties;
wherein the platform integrates service provider recommendations and scheduling, including for plumbing, construction, and moving, to assist in completing real estate transactions efficiently.
